(19) United States
(12) Patent Application Publication
(10) Pub. No.: US 2026/0177475 A1
(43) Pub. Date: Jun. 25, 2026

(54) SIMULTANEOUS MULTI-WAVELENGTH AND MULTI-ANGLE ELLIPSOMETRY

(71) Applicant: Onto Innovation Inc., Wilmington, MA (US)

(72) Inventors: Alex RUDER, Budd Lake, NJ (US); Michael GILMORE, Bend, OR (US); Matthew SARTIN, Budd Lake, NJ (US); Michael J. KOTELYANSKII, Chatham, NJ (US); Frank Vozzo, Randolph, NJ (US); Manjusha MEHENDALE, Morristown, NJ (US); George Andrew ANTONELLI, Flanders, NJ (US)

(73) Assignee: Onto Innovation Inc., Wilmington, MA (US)

(21) Appl. No.: 18/990,795

(22) Filed: Dec. 20, 2024

(51) Int. Cl. G01N 21/21

(52) U.S. Cl. CPC G01N 21/211; G01N 2021/214; G01N 2201/06113; G01N 2201/062; G01N 2201/0636

(57) ABSTRACT

Angle resolved, multiple wavelength ellipsometry is performed using a light source that produces light having multiple wavelengths with each wavelength modulated with a different characteristic. The wavelengths are co-linearly incident on the sample over a range of angles of incidence. A single detector array receives the reflected light, with different pixels in the array that correspond to different angles of incidence to provide angle resolved measurements. The signals from each pixel are demodulated based on the modulation characteristics of the wavelengths to recover wavelength information for the different angles of incidence. The characteristics can include at least frequency, code, shape, or some combination thereof.

### FIELD OF THE DISCLOSURE

The subject matter described herein is related generally to optical metrology, and more particularly to systems and processes for performing ellipsometry.

### BACKGROUND

Semiconductor and other similar industries often use metrology equipment, such as optical metrology equipment, to provide non-contact evaluation of samples during processing. With optical metrology, a sample under test is illuminated with light, e.g., at a single wavelength or multiple wavelengths. After interacting with the sample, the resulting light is detected and analyzed to determine one or more characteristics of the sample.

Ellipsometry is one type of optical metrology in which light with a known polarization state is incident on and reflected from a sample, and the polarization state of the reflected light is analyzed to quantify the change in polarization state produced by the sample. The ellipsometry measurements may be acquired at multiple incident angles to produce angle resolved measurements. Additionally, it is sometimes desirable to acquire ellipsometry measurements at multiple wavelengths. Acquiring data at multiple incident angles and multiple wavelengths typically requires separately detecting and measuring each wavelength at each incident angle, adding complexity and expense to the system. Moreover, alterations to the ellipsometer, such as adding or changing wavelengths, require significant modifications to the detector arm.

### SUMMARY

Angle resolved, multiple wavelength ellipsometry is performed using a light source that produces multiple wavelengths that are encoded based on different characteristics. Each wavelength can be modulated with a different frequency, waveform shape, code such as orthogonal code or a combination thereof. The frequency modulation or encoding a code does not change the wavelength or frequency of the underlying spectrum, but modulates or encodes additional information that can be used to separate out the waveforms afterwards. All wavelengths are combined into a single beam and are co-linearly incident on the sample over a range of angles of incidence. A single detector array detects the light reflected from the sample, with different pixels in the array receiving different reflection angles of the reflected light and, equivalently, different angles of incidence of the incident light, to provide angle resolved measurements. The signals from each pixel are separately demodulated based on the modulation frequencies to recover wavelength information for all wavelengths at each of the different angles of incidence. Additionally, the light may be polarization state modulated and the signals from each pixel demodulated at the polarization state modulation frequencies to generate the angle resolved, multiple wavelength ellipsometric data.

In one implementation, a method for performing angle resolved, multiple wavelength ellipsometry includes generating light with multiple wavelengths from a light source and modulating each wavelength with a different characteristic. The method further includes focusing the light on a sample over a range of incident angles with an objective lens and detecting reflected light from the sample with a photodetector array having a plurality of pixels. Different pixels in the plurality of pixels detect reflected light that corresponds to different incident angles and that includes all of the multiple wavelengths. The method further includes demodulating a signal produced by each pixel in the plurality of pixels for each different characteristic to produce ellipsometric measurements for multiple incident angles at the multiple wavelengths.

In one implementation, a metrology device is configured for angle resolved multiple wavelength ellipsometry and includes a light source that generates light with multiple wavelengths and a means for modulating each wavelength with a different characteristic. An objective lens focuses the light on a sample over a range of incident angles. The metrology device further includes a photodetector array having a plurality of pixels that detects reflected light from the sample. Different pixels in the plurality of pixels detect reflected light that corresponds to different incident angles and that includes all of the multiple wavelengths. The metrology device further includes a means for demodulating a signal produced by each pixel in the plurality of pixels in the photodetector array for each different characteristic to produce ellipsometric measurements for multiple incident angles at the multiple wavelengths.

### BRIEF DESCRIPTION OF THE DRAWINGS

FIG. 1 illustrates a schematic view of a metrology device that may be configured for multi-wavelength and multi-angle data acquisition, as described herein.

FIG. 2 shows a high level illustration of a multiple wavelength ellipsometer.

FIG. 3 shows a high level illustration of an ellipsometer configured for multi-wavelength, angle resolved ellipsometry, in accordance with one implementation.

FIG. 4 illustrates a light source that may be used with ellipsometer of FIG. 3, in which external modulation is used to modulate the characteristics of the different wavelengths.

FIG. 5 shows an illustrative flowchart depicting an example method for performing multi-wavelength, angle resolved ellipsometry, according to some implementations.

### DETAILED DESCRIPTION

During fabrication of semiconductor devices and similar devices it is often necessary to monitor the fabrication process by non-destructively measuring the devices. Optical metrology techniques, such as ellipsometry, are employed for non-contact evaluation of samples during processing. A sample can be a wafer, a panel, or any other type of substrate.

Angle resolved ellipsometry acquires ellipsometric data at a plurality of angles of incidence. Angle resolved ellipsometers, for example, are sometimes configured to vary the incident angle of the incident light by physically adjusting the orientations of the delivery and receiving arms of the ellipsometer, e.g., using a goniometer. An ellipsometer may be configured to acquire angle resolved data using an objective lens with a high numerical aperture (NA) to focus the light on the sample over a range of incidence angles. Different reflection angles of the reflected light and, equivalently, different incident angles of the incident light, are detected by different pixels in a photodetector array. To additionally acquire multiple wavelength information for each angle of incidence, an ellipsometer may introduce the wavelengths sequentially, or may include dispersive or dichroic optical elements in the detection path and use separate detectors or pixels to measure the signal corresponding to the individual wavelengths. The use of multiple detectors or pixels to acquire wavelength data with angle resolved ellipsometry adds complexity and expense to the device. Moreover, modifying the metrology device, e.g., to add or change wavelengths, requires significant modifications in the detection arm.

As discussed herein, an angle resolved, multiple wavelength ellipsometer may use measure multiple wavelengths and incident angles simultaneously using only a single array detector. The simultaneous measurement of multiple incidence angles is achieved by using a high NA objective lens to focus the light at multiple angles of incidence. The light is detected by a single, e.g., a one-dimensional, array of pixels, which is positioned so that each pixel is associated with a reflection angle and, by extension, an incidence angle. All wavelengths are introduced simultaneously, using light sources that generate different wavelengths that are combined along the same optical path, so that all wavelengths are received by each pixel in the detector array. The light corresponding to each wavelength is modulated with a different frequency, code, or shape or a combination thereof, so that the demodulation of the data from each pixel in the detector yields angle resolved ellipsometric data of the corresponding wavelength. Accordingly, ellipsometry with simultaneous acquisition of angle resolved, multiple wavelength data may be performed without significantly increasing the measurement time or the complexity of the detector. Moreover, since only a single detection path is used, wavelengths can be changed or added with minimal changes to the system.

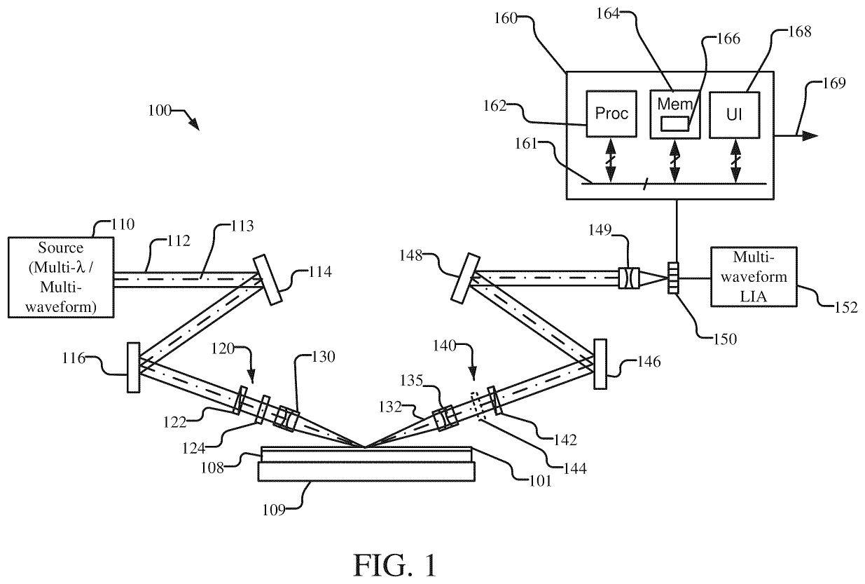

FIG. 1, by way of example, illustrates a schematic view of a metrology device 100 that may be configured for multi-wavelength and multi-angle data acquisition, as described herein. The metrology device 100 may be configured, for example, to acquire data at a plurality of angles of incidence with respect to a sample along an optical axis. The metrology device 100 may be an oblique incidence ellipsometer, as illustrated, but may be normal incidence if desired. Additionally, if desired, the metrology device 100 may include multiple heads, i.e., additional devices, that may be combined with the device illustrated in FIG. 1.

The metrology device 100 includes a light source 110 that produces light 112 that has multiple wavelengths (multi-λ). For example, the light source 110 may produce two wavelengths, e.g., at 405 nm and 633 nm, or additional wavelengths, e.g., up to ten or more wavelengths. The light source 110, for example, may include a plurality of lasers or a plurality of light emitting diode (LED)s (or any combination thereof) that each produce a beam with a different wavelength of light that are combined to be colinear along the same optical axis 113. In some implementations, the light source may be a broadband source, such as a Xenon or Tungsten Halogen light source, that produces broadband light and one or more wavelength separators, such as dichroic mirrors or diffraction gratings, are used to produce a beam with a different wavelength of light that are combined to be colinear along the same optical axis 113.

The light source 110 additionally encodes each separate wavelength of the light 112 with a different characteristic. The characteristic, for example, may differ in frequency, code, shape or a combination thereof. For example, in some implementations, the light is modulated, e.g., turned on and off, using a different (orthogonal) code for each different wavelength. In some implementations, the intensity of the light may be modulated using different frequencies, for example, using different frequencies to encode different wavelengths, e.g., the light of each wavelength (λ₁, λ₂, . . . λ_{N}) is turned on and off at a different frequency (f₁, f₂, . . . f_{N}). In some implementations, the light may be modulated using waveforms that differ in shape, for example, using different codes, e.g., orthogonal codes, to encode the different wavelengths, e.g., where the light of each wavelength (λ₁, λ₂, . . . λ_{N}) is turned on and off with a waveform based on a different code (c₁, c₂, . . . c_{N}). The light source may encode each wavelength, in some implementations, by direct modulation or external modulation. For example, with direct modulation, the intensity of the light is modulated by modulating the voltage or current supplied to each of the plurality of lasers or LEDs, e.g., using a waveform generator. With external modulation, the light is modulated after the light is emitted, e.g., by a light modulator placed in the beam path of each different wavelength. The external modulation may be performed using a chopper wheel, an acousto-optic modulator (AOM), or an electro-optic modulator (EOM) or photoelastic modulator (PEM) in which the incoming light is polarized and the exit aperture is followed by a polarizer.

As illustrated, the light 112 may be directed by one or more optical elements illustrated by mirrors 114 and 116 to focusing optical elements 130, e.g., objective lens, that directs and focuses the light 112 on the sample 101. The metrology device 100 includes a polarization state generator 120 between the light source 110 and the focusing optical elements 130. The polarization state generator 120 controls the polarization state of the light 112 that is incident on the sample 101. The polarization state generator 120, for example, may include a static or rotating polarizer 122, which may be a linear or circular polarizer. Additionally, in some implementations, the polarization state generator 120 further includes a polarization state modulator 124. The polarization state modulator 124, for example, may be constructed based on a high speed, axially stationary optical phase modulator, such as a photoelastic modulator (PEM), an electro-optic modulator (EOM), or in some implementation the polarization state modulator 124 may be a rotating compensator, e.g., phase retarder, a rotating waveplate, etc. The polarization state may also be modulated by modulating the amplitude of one or more polarization states. The polarization state modulator 124, for example, may have a modulation frequency of f_{PSM}.

The focusing optical elements 130 may include one or more refractive or reflective lenses and focus each of the different wavelengths of light 112 to be colinearly incident on a sample 101 over a range of incident angles around the optical axis 113. For example, in some implementations, the focusing optical elements 130 may have a numerical aperture (NA) with a half-angle of at least 5 degrees, 7 degrees, 10 degrees, or more.

On the receiving side of the metrology device 100, i.e., after the sample 101, or a combination thereof, optical elements 135 receive the reflected light 132 from the sample 101, which includes a plurality of wavelengths, each of which is encoded with the different modulation characteristic. The optical elements 135 receives the reflected light over a range of angles around the optical axis 113 that corresponds to the range of incidence angles produced by the focusing optical elements 130. The optical elements 135 include one or more refractive or reflective lenses, or a combination thereof, and may match the optical elements 130 on the delivery side of the metrology device 100, i.e., before the sample 101.

The metrology device 100 further includes a polarization state analyzer 140 on the receiving side, i.e., after the sample 101. The polarization state analyzer 140 receives the reflected light 132 from the optical elements 135 and is used to quantify the change in polarization state of the light that is caused by the sample 101. The polarization state analyzer 140 may be static or modulating. For example, the polarization state analyzer 140, for example, may include a static or rotating polarizer 142, which may be a linear or circular polarizer. Additionally, in some implementations, the polarization state analyzer 140 may further include a polarization state modulator 144 between the sample 101 and the polarizer 142, if present. Similar to polarization state modulator 124, polarization state modulator 144 may be a high speed, axially stationary, optical phase modulator, such as a PEM, EOM, or may be a rotating compensator. The polarization modulation may also be achieved by modulating the amplitude of one or more polarization states in the system. In some implementations, the metrology device 100 may include one polarization state modulator either on the delivery side, e.g., illustrated by polarization state modulator 124, or on the receiving side, e.g., illustrated by polarization state modulator 144, or may include polarization state modulators on both the delivery side and receiving side, e.g., both polarization state modulators 124 and 144. If the polarization state modulator 144 is present, and the polarization state modulator 124 on the delivery side is not used, the polarization state modulator 144 may have a modulation frequency of f_{PSM}. If both polarization state modulator 124 and polarization state modulator 144 are present, they may use different modulation frequencies, e.g., f_{PSM} and f_{PSM}′, respectively. For ease of reference, as discussed herein, the polarization state modulator in the metrology device 100 may be referred to and illustrated as polarization state modulator 124 on the delivery side, but it should be understood that unless stated otherwise, the polarization state modulator may be present on only the receiving side, or on both the delivery side and receiving side of the metrology device.

As illustrated, the reflected light 132, after being received by the optical elements 135 and the polarization state analyzer 140, may be directed by one or more optical elements illustrated by mirrors 146 and 148 to a detector 150. As illustrated, one or more lenses 149 may receive the reflected light 132 from the polarization state analyzer 140 and focus the light on the detector 150. The detector 150 may be photodetector array having a plurality of pixels, where each pixel in the array is associated with a different reflection angle, and by extension, a corresponding incidence angle. For example, the detector 150 may be a single, one-dimensional array of pixels, which is configured so that each pixel receives a different reflection angle of the reflected light 132 and, equivalently, a different incidence of angle. Each pixel in the array of pixels receives all of the multiple wavelengths, each of which being encoded with a different modulation characteristic.

The wavelength information in the signal produced by each of the plurality of pixels in the detector 150 in response to detecting the reflected light 132 is decoded by demodulating the light based on the different characteristics used to modulate the wavelengths. In some implementations, a lock-in amplifier 152 may be coupled to the detector 150 and used to demodulate the signal produced by each of the plurality of pixels in the detector 150. The lock-in amplifier 152, for example, may demodulate each of the different frequencies (f₁, f₂, . . . f_{N}) in the reflected light 132 received by each of the plurality of pixels to decode the plurality of wavelengths. In some implementations, each pixel in the detector 150 may be coupled to a separate lock-in amplifier 152, and each lock-in amplifier 152 demodulates each of the different frequencies used by the light source 110 to encode the separate wavelengths. In some implementations, at least one computing system 160, instead of a dedicated lock-in amplifier(s), may receive the signal from the detector 150 and may demodulate the reflected light 132 based on the different characteristics used to modulate the wavelengths. For example, the at least one computing system 160 may demodulate each of the different frequencies or each of the different codes used to modulate the light. Additionally, the polarization state modulation frequency or frequencies, f_{PSM} and/or f_{PSM}′, of the polarization state modulator 124 and/or polarization state modulator 144 in the signal produced by each of the plurality of pixels in the detector 150 in response to detecting the reflected light 132 may be demodulated using the lock-in amplifier 152 and/or computing system 160. For example, if the light 112 includes both modulation of the light based on different characteristics for different wavelengths and polarization state modulation, both the modulation of the characteristic of the light and the polarization state modulation may be demodulated. For example, each pixel in the detector 150 may be demodulated for each of the different intensity modulation frequencies and the polarization state modulation frequency (f_{PSM}±f₁, f_{PSM}±f₂, . . . f_{PSM}±f_{N}).

It should be understood that additional or fewer components may be present in the metrology device 100, e.g., in the optical train. For example, additional, fewer, or different directional components or mirrors may be present. Further, additional components used for beam conditioning or shaping may be present, as is well known in the art. Further, while FIG. 1 illustrates the metrology device 100 using obliquely incident light, the metrology device 100 may be configured to use normally incident light, e.g., by including a beam splitter to direct incident light 112 towards the sample 101 and to direct reflected light 132 towards the detector 150 and removing optical elements 135.

Metrology device 100 further includes at least one computing system 160 that is communicatively coupled to the detector 150 to receive measurement data acquired by the detector 150. The computing system 160 is further configured to control and monitor operation of the metrology device 100, including the light source 110, polarization state generator 120 and polarization state analyzer 140, either of which, or both, include a polarization state modulator 124, detector 150 and lock-in amplifier 152, as well as the chuck 108, stage 109, etc. The computing system 160, for example, may be configured to control the chuck 108 and stage 109 to control the position and orientation of the sample 101 during measurement. The computing system 160 may be configured to control the light source 110 to encode the modulation of the characteristic for the different wavelengths, to control and acquire information from one or more subsystems of the metrology device 100 such as the detector 150 and lock-in amplifier 152, polarization state generator 120 and polarization state analyzer 140 to acquire resulting measurement data, and to determine one or more parameters of the sample 101 based on acquired measurement data. The computing system 160 may be configured to control and acquire data from various one or more subsystems of the metrology device 100, e.g., by a transmission medium that may include wireline and/or wireless portions. The transmission medium, thus, may serve as a data link between the computing system 160 and other subsystems of the metrology device 100.

The at least one computing system 160, for example, may be a workstation, a personal computer, central processing unit or other adequate computer system, or multiple systems. It should be understood that the at least one computing system 160 may be a single computer system or multiple separate or linked computer systems, including one or more processors which may be coupled to one or more computational nodes (blades), which may be interchangeably referred to herein as computing system 160, at least one computing system 160, one or more computing systems 160, etc. In some implementations, the computing system 160 or components of the computing system 160 may be separate from the metrology device 100 while in some implementations, the computing system 160 may be included in or is connected to or otherwise associated with metrology device 100. Additionally, different subsystems of the metrology device 100 may each include a computing system that is configured for carrying out steps associated with the associated subsystem. For example, the at least one computing system 160 may be coupled to a separate computing system that is associated with the detector 150.

The computing system 160 includes at least one processor 162 with memory 164, as well as a user interface (UI) 168, which are communicatively coupled via a bus 161. The memory 164 or other non-transitory computer-usable storage medium, includes computer-readable program code 166 embodied thereof and may be used by the computing system 160 for causing the at least one computing system 160 to control the metrology device 100 and/or to perform functions including encoding the angular distribution of the incident light, as described herein. The data structures and software code for automatically implementing one or more acts described in this detailed description can be implemented by one of ordinary skill in the art in light of the present disclosure and stored, e.g., on a computer-usable storage medium, e.g., memory 164, which may be any device or medium that can store code and/or data for use by a computer system, such as the computing system 160. The computer-usable storage medium may be, but is not limited to, include read-only memory, a random access memory, magnetic and optical storage devices such as disk drives, magnetic tape, etc. Additionally, the functions described herein may be embodied in whole or in part within the circuitry of an application specific integrated circuit (ASIC) or a programmable logic device (PLD), and the functions may be embodied in a computer understandable descriptor language which may be used to create an ASIC or PLD that operates as herein described.

The computing system 160 may be configured to determine one or more characteristics of the sample 101 based on metrology data acquired by detector 150, as well as other metrology device 100 configurations, such as the multiple angles of incidence and multiple wavelengths of the light, the orientations or states of one or more of the polarization state generator 120 and polarization state analyzer 140. By way of example, the computing system 160 may determine one or more characteristics of the sample 101 using known ellipsometry and other metrology techniques. The results from the analysis may be stored, e.g., in memory 164 associated with the sample and/or provided to a user, e.g., via the UI 168. In some implementations, the results of the analysis may be provided, e.g., via port 169, to other metrology systems to assist with additional measurements or inspection or fed back or fed forward to processing systems for adjusting processing steps in response to the analysis.

The metrology device 100 is advantageously configured to perform ellipsometry at multiple wavelengths and incident angles simultaneously, using only a single array detector 150, which enables rapid data acquisition and does not significantly increase the complexity of the detector 150. For example, in a conventional approach to performing ellipsometry with multiple wavelengths, either the wavelengths are introduced sequentially or dispersive or dichroic optical elements are placed in the detection path, and multiple detectors or pixels are used to measure the signal corresponding to the individual wavelengths. Metrology device 100, in contrast, enables simultaneous multi-wavelength, angle-resolved ellipsometry using in some embodiments a single row of detector pixels, with each pixel receiving all wavelengths different. Moreover, since only a single detection path is used for all wavelengths, wavelengths may be changed or added with only minimal changes to the configuration of the metrology device 100.

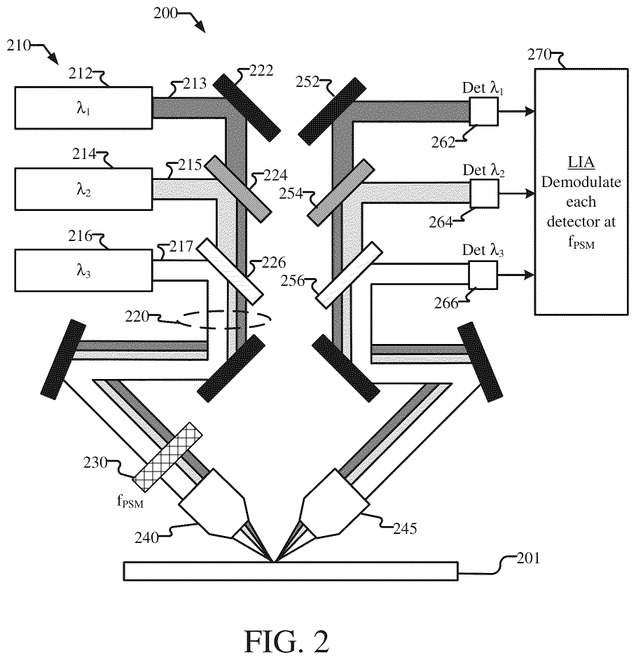

FIG. 2 shows a high level illustration of a multiple wavelength ellipsometer 200. As illustrated, ellipsometer 200 includes a light source 210 that includes a plurality of lasers 212, 214, and 216, producing light 213, 215, and 217 having wavelengths λ₁, λ₂, and λ₃, respectively. The paths of the light 213, 215, and 217 are combined into a single beam of light 220 using a mirror 222 and dichroic mirrors 224 and 226. It should be understood that the light 213, 215, and 217, which have different wavelengths, are combined so that they are co-linear, but FIG. 2 illustrates the light 213, 215, and 217 within combined light 220 as offset for clarity.

The combined light 220 is directed to the sample 201 using one or more optical elements, e.g., illustrated as mirrors, and focusing optical element 240. FIG. 2 illustrates the use of a polarization state modulator 230 on the delivery side of the ellipsometer 200, i.e., before the sample 201. The polarization state modulator 230 uses a modulation frequency of f_{PSM}. The reflected light is received by optical element 245 and is directed by one or more optical elements, e.g., illustrated as mirrors, to multiple detectors 262, 264, and 266 that receive the different wavelengths λ₁, λ₂, and λ₃ via mirror 252 and dichroic mirrors 254 and 256, respectively. Ellipsometers sometimes use diffractive optical elements to separate the different wavelengths instead of dichroic mirrors. Each of the multiple detectors 262, 264, and 266 are coupled to a lock-in amplifier 270 that is used to demodulate the polarization state modulation frequency f_{PSM} in the signal produced by each of the detectors 262, 264, and 266 in response to detecting the reflected light.

As can be seen in FIG. 2, the ellipsometer 200 requires a number of separate detectors (or group of pixels in a pixel array) that corresponds to the number of wavelengths. If additional wavelengths are to be added to the ellipsometer 200, additional detectors and dichroic mirrors (or diffractive optical elements) are required. Similarly, a change in the wavelengths used in the ellipsometer 200 requires a corresponding change detection system, e.g., change in the detectors and dichroic mirrors (or diffractive optical elements). This can be expensive and burdensome in practice.

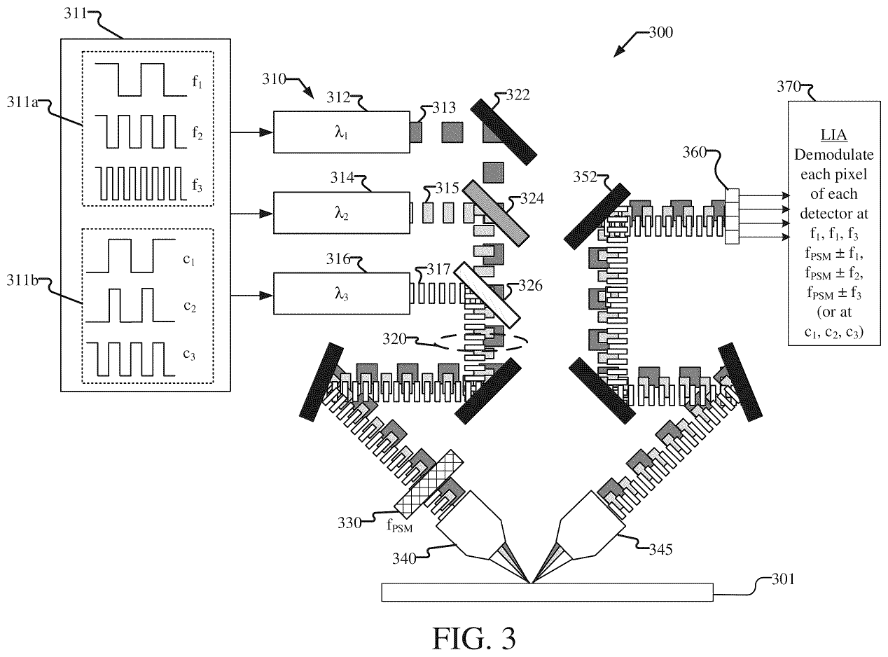

FIG. 3 shows a high-level illustration of an ellipsometer 300 configured for multi-wavelength, angle resolved ellipsometry, in accordance with one implementation. The portion of the ellipsometer 300 shown in FIG. 3, by way of example, may include one or more of the components illustrated in metrology device 100 shown in FIG. 1.

As illustrated, ellipsometer 300 includes a light source 310 that includes a plurality of lasers 312, 314, and 316, producing light 313, 315, and 317 having wavelengths λ₁, λ₂, and λ₃, respectively. In some implementations, LEDs may be used in place of lasers 312, 314, and 316. The light source 310 includes a waveform generator 311 that modulates the voltage or current supplied to each of the plurality of lasers 312, 314, and 316 with a different characteristic. For example, as illustrated by block 311a, the waveforms may have different frequencies, f₁, f₂, and f₃, which are supplied to lasers 312, 314, and 316 respectively. In another example, as illustrated by block 311b, the waveforms may have different shapes produced by orthogonal codes, c₁, c₂, and c₃, which are supplied to lasers 312, 314, and 316 respectively. Consequently, the intensity of the light at each different wavelength (λ₁, λ₂, λ₃) is modulated, e.g., turned on and off, according to different characteristic.

The paths of the light 313, 315, and 317 are combined into a single beam of light 320 using a mirror 322 and dichroic mirrors 324 and 326. It should be understood that the light 313, 315, and 317, which have different wavelengths, are combined so that they are co-linear, but FIG. 3 illustrates the light 313, 315, and 317 within combined light 320 as offset for clarity. While FIG. 3 illustrates the use of dichroic mirrors 324 and 326 to combine the light 313, 315, and 317, it should be understood that the light may be combined in other ways, e.g., using a multiplexer to merge fibers supporting the different laser wavelengths.

The combined light 320 is directed to the sample 301 using one or more optical elements, e.g., illustrated as mirrors, and focusing optical element 340. FIG. 3 illustrates the use of a polarization state modulator 330 on the delivery side of the ellipsometer 300, i.e., before the sample 301. The polarization state modulator 330 uses a modulation frequency of f_{PSM}. If desired, the polarization state modulator 330 may be on the receiving side of the ellipsometer, or both on the deliver side and receiving side of the ellipsometer. Additionally, additional polarization components may be included in the ellipsometer, such as stationary or rotating polarizers or waveplates, on the delivery side and receiving side, serving as polarization state analyzer and polarization state analyzer, which may be used to recover desired elements of the Mueller matrix. The reflected light is received by optical element 345 and is directed by one or more optical elements, e.g., illustrated as mirrors, including mirror 352, to a single detector 360 having an array of photodetector pixels. For example, the array of photodetector pixels in the detector 360 may be a one dimensional array.

The ellipsometer 300 performs angle resolved ellipsometry by using focusing optical element 340 with a high numerical aperture, e.g., NA of 0.087, or 0.12, or 0.17, to focus the light 320 on the sample 301 with a half-angle of at least 5 degrees, 7 degrees, 10 degrees, or more, and sampling the signals corresponding to the different incident angles by dispersing the reflected them onto different pixels of a 1-D array detector. Each pixel in the detector 360, for example, may be associated with a different reflection angle, and by extension, a corresponding incidence angle. Additionally, each pixel in the detector 360 receives all of the multiple wavelengths λ₁, λ₂, and λ₃, that are each intensity modulated with a different characteristic, e.g., f₁, f₂, and f₃, respectively or c₁, c₂, and c₃, respectively. Thus, the different incident angles are dispersed onto different pixels of the detector 360, but only one detector is used, since the wavelengths are distinguished by the applied modulation characteristic.

As illustrated, the detector 360 may be coupled to a lock-in amplifier 370 that is used to demodulate the signal received from each pixel in the detector 360 based on the characteristic used to modulate the different wavelengths. For example, the demodulation of the signal received at each pixel may be based on the frequencies f₁, f₂, and f₃, of the modulation or the codes c₁, c₂, and c₃. Moreover, if polarization modulation is implemented, the frequency of the polarization modulators may be demodulated with the lock-in amplifier 370. The lock-in amplifier 370, for example, demodulates each of the different intensity modulation waveforms from each pixel in order to determine ellipsometric data for both wavelength and angle of incidence simultaneously. The lock-in amplifier 370 may additionally demodulate the polarization state modulation frequency f_{PSM}, with the intensity modulation frequencies if used, e.g., f_{PSM}±f₁, f_{PSM}±f₂, f_{PSM}±f₃. Thus, the approach illustrated by ellipsometer 300 in FIG. 3, enables simultaneously multi-wavelength, angle-resolved ellipsometry using a single row of detector pixels.

The modulation of the different wavelengths of light may be performed in various manners. For example, while FIG. 3 illustrates direct modulation in which the intensity of the light is modulated using a waveform generator 311 to modulate the voltage or current supplied to each of the lasers 312, 314, and 316, the intensity of the light may be modulated using external modulation in which the modulation is performed emission of the light 313, 315, and 317.

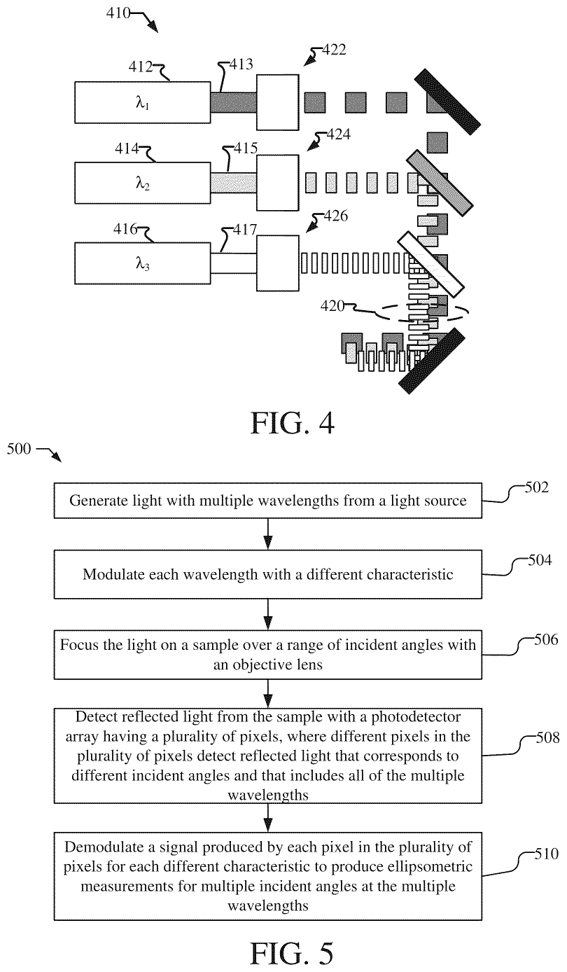

FIG. 4, by way of example, illustrates a light source 410 that may be used with ellipsometer 300, in which the modulation of the different wavelengths is performed after the light is produced, but before the wavelengths are combined into beam 420, using light modulators 422, 424, and 426. As illustrated, the light source 410 includes light emitters, e.g., lasers 412, 414, and 416, that emit light 413, 415, and 417 with wavelengths λ₁, λ₂, λ₃, respectively. The light modulators 422, 424, and 426 are external to the lasers 412, 414, and 416, and accordingly, may sometimes be referred to as external modulators. In some implementations, LEDs may be used in place of lasers 412, 414, and 416. In some implementations, a broadband light source may be used with one or more wavelength separators, such as dichroic mirrors or a diffraction grating, to produce light 413, 415, and 417 with the separate wavelengths λ₁, λ₂, and λ₃.

Light modulators 422, 424, and 426 are in the beam path of light 413, 415, and 417, and are used to modulate the separate wavelengths λ₁, λ₂, and λ₃, with different characteristics, e.g., having different frequencies, f₁, f₂, and f₃, respectively, or in some implementations with different orthogonal codes, c₁, c₂, and c₃. The light modulators 422, 424, and 426, for example, may include a polarizer followed by a PEM followed by another polarizer, an EOM followed by another polarizer, or an AOM. In some implementations, the light modulators 422, 424, and 426, may be chopper wheels, e.g., disks that physically rotate and include one or more openings with different spacings to modulate the intensity of the light 413, 415, and 417 with different waveforms. In some implementations, a single chopper wheel may be used, which for example, may include different patterns at different radii of the disk, and the different wavelengths are incident on the disk at the different radii.

FIG. 5 shows an illustrative flowchart depicting an example method 500 for performing for multi-wavelength, angle resolved ellipsometry, as discussed herein. In some implementations, the example method 500 may be performed by a metrology device, such as a metrology device 100 or ellipsometer 300 illustrated in FIG. 1 or 3, respectively.

As illustrated in FIG. 5, the method includes generating light with multiple wavelengths from a light source (502), e.g., as illustrated and discussed in relation to light source 110, 310, and 410, in FIGS. 1, 3, and 4. For example, the light may be produced by multiple lasers, or LEDs, or broadband light source with wavelength separator to produce light with multiple wavelengths separately.

The method further includes modulating each wavelength with a different characteristic (504), e.g., as illustrated and discussed in relation to light sources 110, 310, 410, and 410, in FIGS. 1, 3, and 4. In some implementations, a means for modulating each wavelength with a different characteristic may include a waveform generator that drives a plurality of light sources with different frequencies, as illustrated and discussed in relation to waveform generator 311 and light sources 312, 314, and 316, in FIG. 3, or with at least one of photoelastic modulators (PEMs), acousto-optic modulators (AOMs), electro-optic modulators (EOMs), or chopping wheels, illustrated and discussed in relation to intensity modulators 422, 424, and 426 in FIG. 4. For example, the different waveforms may differ in at least one of frequency, shape, code, or a combination thereof. In some implementations, the light for each wavelength may be modulated, e.g., turned on and turned off, with a different frequency. In some implementations, the intensity of the light for each wavelength may be modulated, e.g., turned on and turned off, based on waveform shapes generated with different orthogonal codes.

The light is focused on a sample over a range of incident angles with an objective lens (506), e.g., as illustrated and discussed in relation to focusing optical elements 130 and 340 in FIGS. 1 and 3. For example, the objective lens may have a numerical aperture (NA) with a half-angle of at least 5 degrees.

The reflected light is detected from the sample with a photodetector array having a plurality of pixels, where different pixels in the plurality of pixels detect reflected light that corresponds to different incident angles and that includes all of the multiple wavelengths (508), e.g., as illustrated and discussed in relation to detectors 150 and 360 in FIGS. 1 and 3.

The signal produced by each pixel in the plurality of pixels is demodulated for each different characteristic to produce ellipsometric measurements for multiple incident angles at the multiple wavelengths (510), e.g., as illustrated and discussed in relation to lock-in amplifiers 152 and 370 and computing system 160 in FIGS. 1 and 3. In some implementations, a means for demodulating a signal produced by each pixel in the plurality of pixels in the photodetector array for each different characteristic to produce ellipsometric measurements for multiple incident angles at the multiple wavelengths may include at least one of a lock-in amplifier or a processor coupled to the photodetector array, e.g., as illustrated and discussed in relation to lock-in amplifiers 152 and 370 and computing system 160 in FIGS. 1 and 3.

In some implementations, the light source may include a plurality of light sources that produce light with different wavelengths and one or more dichroic mirrors to combine the light from each of the plurality of light sources, e.g., as illustrated and discussed in relation to light source 110 in FIG. 1 and light source 310 and dichroic mirrors 324 and 326 in FIG. 3. For example, the plurality of light sources may include light emitting diodes, or lasers, or a combination of light emitting diodes and lasers. In some implementations, modulating each wavelength may include direct modulation of the plurality of light sources, e.g., as illustrated and discussed in relation to light source 110 in FIG. 1 and light source 310, including waveform generator 311 in FIG. 3. In some implementations, modulating each wavelength may include external modulation of the light after the light is produced by each the plurality of light sources and before it is combined by the one or more dichroic mirrors, e.g., as illustrated and discussed in relation to light source 110 in FIG. 1 and light source 410. For example, the modulating the characteristic of the light may be performed by at least one of photoelastic modulators (PEMs) with polarizers, acousto-optic modulators (AOMs), electro-optic modulators (EOMs) with polarizers, or chopping wheels, as illustrated and discussed in relation to light modulators 422, 424, and 426 in FIG. 4.

In some implementations, the method may further include modulating a polarization state of the light with a polarization state modulator at a polarization modulation frequency, e.g., as illustrated and discussed in relation to polarization state modulators 124 and 330 in FIGS. 1 and 3. The polarization state modulator, for example, may be an optical phase modulator such as a rotating compensator, a photoelastic modulator (PEM), or an electro-optic modulator (EOM). Alternatively, it could be achieved by modulating the amplitude of one or more polarizations of light, for example using an acousto-optic modulator (AOM). In some implementations, demodulating the signal produced by each pixel in the plurality of pixels may be further based on the polarization modulation frequency of the polarization state modulator, e.g., as illustrated and discussed in relation to lock-in amplifiers 152 and 370 in FIGS. 1 and 3.

The above description is intended to be illustrative, and not restrictive. For example, the above-described examples (or one or more aspects thereof) may be used in combination with each other. Other implementations can be used, such as by one of ordinary skill in the art upon reviewing the above description. Also, various features may be grouped together and less than all features of a particular disclosed implementation may be used. Thus, the following aspects are hereby incorporated into the above description as examples or implementations, with each aspect standing on its own as a separate implementation, and it is contemplated that such implementations can be combined with each other in various combinations or permutations. Therefore, the spirit and scope of the appended claims should not be limited to the foregoing description.

What is claimed is:

1. A method for performing angle resolved, multiple wavelength ellipsometry, comprising:
generating light with multiple wavelengths from a light source;
modulating each wavelength with a different characteristic;
focusing the light on a sample over a range of incident angles with an objective lens;
detecting reflected light from the sample with a photodetector array having a plurality of pixels, wherein different pixels in the plurality of pixels detect reflected light that corresponds to different incident angles and that includes all of the multiple wavelengths; and
demodulating a signal produced by each pixel in the plurality of pixels for each different characteristic to produce ellipsometric measurements for multiple incident angles at the multiple wavelengths.

2. The method of claim 1, wherein the different characteristics differ in at least one of frequency, shape, code, or a combination thereof.

3. The method of claim 1, wherein the light source comprises a plurality of light sources that produce light with different wavelengths and one or more dichroic mirrors to combine the light from each of the plurality of light sources.

4. The method of claim 3, wherein the plurality of light sources comprise light emitting diodes, or lasers, or a combination of light emitting diodes and lasers.

5. The method of claim 3, wherein modulating each wavelength comprises direct modulation of the plurality of light sources.

6. The method of claim 3, wherein modulating each wavelength comprises external modulation of the light after the light is produced by each the plurality of light sources and before it is combined by the one or more dichroic mirrors.

7. The method of claim 6, wherein modulating the characteristic of each wavelength is performed by at least one of photoelastic modulators (PEMs) with polarizers, acousto-optic modulators (AOMs), electro-optic modulators (EOMs) with polarizers, or at least one chopping wheel.

8. The method of claim 1, further comprising modulating a polarization state of the light with a polarization state modulator at a polarization modulation frequency.

9. The method of claim 8, wherein the polarization state modulator comprises at least one of a rotating compensator, a photoelastic modulator (PEM), or an electro-optic modulator (EOM).

10. The method of claim 8, wherein demodulating the signal produced by each pixel in the plurality of pixels is further based on the polarization modulation frequency of the polarization state modulator.

11. The method of claim 1, wherein the objective lens has a numerical aperture (NA) with a half-angle of at least 5 degrees.

12. A metrology device configured for angle resolved, multiple wavelength ellipsometry, comprising:
a light source that generates light with multiple wavelengths;
a means for modulating each wavelength with a different characteristic;
an objective lens that focuses the light on a sample over a range of incident angles;
a photodetector array having a plurality of pixels that detects reflected light from the sample, wherein different pixels in the plurality of pixels detect reflected light that corresponds to different incident angles and that includes all of the multiple wavelengths; and
a means for demodulating a signal produced by each pixel in the plurality of pixels in the photodetector array for each different characteristic to produce ellipsometric measurements for multiple incident angles at the multiple wavelengths.

13. The metrology device of claim 12, wherein the different characteristics differ in at least one of frequency, shape, code, or a combination thereof.

14. The metrology device of claim 12, wherein the light source comprises a plurality of light sources that produce light with different wavelengths and one or more dichroic mirrors to combine the light from each of the plurality of light sources.

15. The metrology device of claim 14, wherein the plurality of light sources comprise light emitting diodes, or lasers, or a combination of light emitting diodes and lasers.

16. The metrology device of claim 14, wherein the means for modulating each wavelength comprises direct modulation of the plurality of light sources with a waveform generator.

17. The metrology device of claim 14, wherein the means for modulating each wavelength comprises external modulation of the light after the light is produced by each the plurality of light sources and before it is combined by the one or more dichroic mirrors.

18. The metrology device of claim 17, wherein the means for modulating the characteristic comprises at least one of photoelastic modulators (PEMs) with polarizers, acousto-optic modulators (AOMs), electro-optic modulators (EOMs) with polarizers, or at least one chopping wheel.

19. The metrology device of claim 12, further comprising a polarization state modulator configured to modulate a polarization state of the light with a polarization modulation frequency.

20. The metrology device of claim 19, wherein the polarization state modulator comprises at least one of a rotating compensator, a photoelastic modulator (PEM), or an electro-optic modulator (EOM).

21. The metrology device of claim 19, wherein the signal produced by each pixel in the plurality of pixels is demodulated further based on the polarization modulation frequency of the polarization state modulator.

22. The metrology device of claim 12, wherein the objective lens has a numerical aperture (NA) with a half-angle of at least 5 degrees.
